(19) United States
(12) Patent Application Publication
(10) Pub. No.: US 2010/0196546 A1
(43) Pub. Date: Aug. 5, 2010

(54) RIMMING COMPOSITION

(76) Inventor: Marc RADOW, (US)

Correspondence Address: Attn: Marc Radow, Suite #200, 16520 Wedge Parkway, Reno, NV, 89511, US

(21) Appl. No.: 12/608,856

(22) Filed: Oct. 29, 2009

Related U.S. Application Data
(63) Continuation of application No. 10/807,947, filed on Mar. 24, 2004, now abandoned.

(51) Int. Cl. A47J 43/00; A23P 1/00

(52) U.S. Cl. 426/86; 426/132; 426/390

(57) ABSTRACT

A viscous solution which serves as a catalyst or facilitator to apply any dry granular, flaked, shaved or powder substance (Spice), to the rim of plastic and glass drink-ware. To apply said Spice on drink-ware made from materials commonly used in the manufacture of drink-ware and used in widespread dining/drinking environments including; plastic, glass, porcelain, ceramic, paper, wax coated, etc., and to apply said Spice in a manner that permits a more evenly distributed Spice application that resists or reduces possible dripping down the drink-ware and protects the Spice from saturation or contamination from the Solution.

### CROSS REFERENCE TO RELATED APPLICATIONS

This is a continuation of U.S. Ser. No. 10/807,947 filed Mar. 24, 2004, published as US2005/0214418, incorporated herein by reference.

### BACKGROUND OF THE INVENTIONS

This application relates to compositions applied to surfaces, for example liquid materials applied to drink-ware rims, for holding other materials, for example dry materials for presentation to a user. In the several examples described, a relatively viscous material is applied to rims of drink-ware so that dry materials, for example Spice or dry granular, flaked, shaved or powder substances can be held on the rim until the beverage and/or dry material is consumed.

These inventions relate to liquids, gels, syrups, juices, water/alcohol based and other viscous materials and/or agents and oils (Coating Solution) which serve to moisten or apply a coating of film on the rim of drink-ware as a catalyst or facilitator to adhere or temporarily hold a Spice to the rim of said drink-ware in the preparation of a beverage of any type, nature, alcoholic or otherwise.

Rimming drink-ware and the preparation of drink-ware with Spice for beverages unto themselves are not novel. The margarita, a cocktail which is generally made with tequila liquor mixed with lime, lemon and other juices and cordials has been served in drink-ware whose rims were commonly moistened with lemon or lime juice, water, or sugar-water and then the rim introduced into a reservoir of salt to hence coat the rim with salt.

The salt application process in the above margarita example had been accomplished by applying a band of water or lemon or lime juice on the rim of the glass and introducing the moistened rim into a dish or reservoir of salt. This moisture generally caused the salt to adhere to the rim of the drink-ware. Such solutions however impart their own flavors into the Spice and then ultimately the beverage. More specifically, while lime juice has been used with some success in the above margarita example, however it would likely perform poorly if it were similarly used with Spices of different flavors including vanilla, chocolate or a host of other Spice alternatives or with drinkware comprised of a material other than glass.

Rimming drink-ware is gaining momentum and popularity as beverage mixologists, food and/or beverage managers and bar tenders (both professional and home consumers) seek to add value to and to create new and exciting beverage preparations. As a result, manufacturers of rimming Spices have developed and market Spice to impart flavors, colors, aromas and textures for the rim in a myriad of combinations.

Formerly, common salt (as identified in the above Margarita example) and sugar were used to rim drink-ware. Today, a number of formulations of Spice varying in combinations of colors, flavors, textures and a host of food science ingredients have been created and intended for this specific rimming purpose. Formulations today include expensive flavors, colors and food ingredients for specific performance criteria. The Spice preparations and finished drinks themselves can be expensive, demand care, artful presentation and must be efficient in terms of preparation time.

Glass, ceramic and particularly drink-ware that is constructed of plastics and waxes have lower surface tensions than that of Spice. As a result, when introduced into Spice, current solutions will have a greater tendency to be attracted to and adhere to the Spice than to that of the materials constructed of the rim of the drink-ware. After repeated uses, e.g. many introductions of moistened rims into reservoirs of Spice, the Spice may tend to become saturated and ultimately become contaminated with the moisture. Contaminated Spice will cluster and form clumps, an undesirable consequence leading to waste and poor presentations.

It is another advantage of the present invention to expedite and facilitate the even distribution and preparation of rimmed drink-ware. Conventional solutions have high water (H₂0) concentrations and therefore have magnetic polarizations associated with water. Such solutions tend to bead into droplets around the surface of the drink-ware rim. Between the droplets of moisture, there is commonly little or no moisture and because the moisture serves as the facilitator to Spice adhering on the rim, when prepared in such a fashion Spice will only adhere to those locations that are moist and in greater quantities in those areas with more moisture. The results are deleterious and those areas that are not moist will be absent Spice and those areas with large droplets will be heavily coated with Spice. This is an undesirable consequence when attempting to rim drink-ware with an even distribution of Spice around the perimeter of the rim.

It is another advantage of the present invention to overcome the low surface tensions of common drink-ware and the generally low Kinematic Viscosity of current solutions, as once Spice is applied to drink-ware, the force of gravity can cause the Spice to descend or drip down the inside and/or outside walls of the drink-ware. Such dripping is an undesirable consequence of present solutions.

The means to prepare beverages in this fashion, e.g. coating drink-ware rims with Spice, have not progressed sufficiently to accommodate the evolution of Spice. The application of Spice has remained ignored; preserving and protecting the Spice from contamination, accommodating plastic drink-ware's infusion into the on-premise and residential marketplace, the ergonomic processes and considerations of beverage preparation, space limitations, the presentation of the spice while in its intended use e.g. ‘on’ the rim of drink-ware, the differences and considerations changing from one spice aroma and flavor to another, and how Coating Solutions are commonly used, stored, cared for, cleaned and so on.

These considerations can be addressed separately or in combination with one or more aspects of a novel Coating Solution.

Where formerly salt or sugar were innocuous ingredients and were call for little attention; the colors, flavors and aromas in current Spice preparations are considerably more expensive and precise. Imperfections or contaminations in the Spice, inconsistencies in preparation and waste are significant impediments to widespread use of drink-ware rimmed with such Spice and beverage preparations.

### BRIEF SUMMARY OF THE INVENTIONS

The Coating Solution may be applied directly to the drink-ware by introducing the drink-ware into a reservoir or container of Coating Solution, or alternatively it may be applied indirectly, whereas the Coating Solution may be applied to an applicator, such as a sponge, then the drink-ware may be introduced to the applicator.

The following examples of compositions and methods of using the compositions provide a number of benefits. Such benefits include more predictable and/or uniform holding of Spice on a rim of drink-ware, more reliable holding of Spice on drink-ware rims of different types of material, and possible taste and color neutral characteristics of the coating material. If desired, the coating material may have preservatives for longer shelf life, both before and during use, and may be formed from materials not subject to regulation by governmental agencies.

In one example of the Coating Solutions described herein, a fluid of a viscosity greater than water is provided, e.g. more than one and a half centipoise (1.5 cp at room temperature, approximately 25 degrees Celsius). In rimming drink-ware, such fluid, for example a liquid, a gel, or other material can be used to coat a drink-ware of the type described herein, which consists of a higher Kinematic viscosity coating (in terms of the Shear Stress divided by the Shear Rate whereas the Shear Stress is equal to the Force divided by the area which is equal to the Mass (M) times the Acceleration (FT/sec/sec) divided by the Ft×Ft) that may provide better adhesion of the Spice, reduce dripping or running of the Spice, may reduce contamination of the Spice supply, and may provide other advantages. In one example provided, the coating composition is an aqueous solution having a viscosity preferably between 100 and 3,000 cp.

In a further example of the coating solutions described herein, an aqueous liquid of a viscosity in the range of 100 and 3,000 cp is provided. In one example, the composition is formed from a texture/viscosity modifier in an aqueous solution. The texture/viscosity modifier may be selected from the groups consisting of consumable sugars, syrups, and/or gums. The composition may also include a surfactant to reduce the surface tension of the aqueous solution. The surfactants may be selected from one or more of the groups of consumable surfactants, e.g. alcohols, glycols, or a polysorbate.

In another example of the coating solutions described herein, an aqueous liquid of a viscosity greater than water having a surfactant is provided. In one example, the composition is formed from a texture/viscosity modifier in an aqueous solution selected from the groups consisting of consumable sugars, syrups, and/or gums. The texture/viscosity modifier may be present in an amount of 0.4% in an aqueous solution of up to 46% water, and the surfactant may be present in the range of 0.9%-21%.

In an additional example of the coating solutions described herein, an aqueous liquid of a viscosity greater than water having a surfactant where the composition is formed from a texture/viscosity modifier in an aqueous solution consisting of corn syrup, xanthan gum, and propylene glycol alginate. In one example, corn syrup is 49.3%, xanthan gum 0.3%, and propylene glycol alginate 0.1%. In the same example, the surfactant is 0.9%.

In one another aspect of one example described herein it is possible to mitigate the contamination of Spice as a result of moisture being introduced into the Spice through repeated rimming efforts. As a result of the lowered surface tension of the Coating Solution, when applied to the rim of drink-ware, the thickness of the application of Solution on the rim is reduced and therefore the amount of Solution used is reduced, however its even distribution affords sufficient surface area to facilitate the same or greater amount of Spice to adhere onto the rim. Further, as a result of the kinematic viscosity, the Wetting Solution will adhere with greater force to the surface of the drink-ware than be overcome by the weight of Spice. As a result, the coated rim will lift the Spice from its container or reservoir and not simply saturate the Spice in a container.

In one another aspect of one example described herein, a coating composition is described that may facilitate satisfactory rimming of drink-ware that is constructed of materials commonly used in the manufacture of drink-ware. As stated above, glass, ceramic, plastics, waxes (and others manufactured from plastic materials) have low surface tensions and the present examples of Coating Solutions reduce the likelihood that the coating composition will bead and cling poorly to such surfaces.

In one another aspect of one example described herein, a coating composition is described that may coat the drink-ware rim so that the Spice does not migrate to areas beyond the intended coating area of the drink-ware. The aforementioned kinematic viscosity of the Wetting Solution may withstand the downward gravitational force on the Wetting Solution and also when the Wetting Solution and Spice are applied together on the drink-ware.

Examples of coating compositions are also described that provide for one single Coating Solution that is color and flavor neutral. Such neutrality will facilitate the application of any Spice product in terms of texture, color, and/or flavor including plastic or glass drink-ware with the same Coating Solution.

In one another aspect of one example described herein, a coating composition is described that affords a shelf and open-air stable solution that resists spoiling and bacterial contamination.

In one another aspect of one example described herein, a coating composition is described that is easily soluble in water and therefore easily cleanable from conventional devices used for rimming purposes, e.g. urethane closed cell sponges.

In one another aspect of one example described herein, a coating composition is described that is ergonomically similar to current Solutions and that can be applied to drink-ware through conventional apparatuses either directly or indirectly, e.g. urethane sponges and uncovered or loosely covered plastic contraptions.

In one another aspect of one example described herein, a coating composition is described that affects and imparts no distinct flavor, aroma or texture to the beverage, drink-ware rim or Spice.

The examples of the coating agent described herein and the methods of use provide a number of benefits. However, one of more of the benefits exemplified herein can be achieved by using fewer than all of the features even though all of the features may not be incorporated into a given composition, or used in a particular method. Further objects and advantages of this invention will be apparent from the following detailed description of presently preferred embodiments and examples along with reference to the accompanying drawings.

### BRIEF DESCRIPTION OF THE DRAWINGS

FIG. 1 is a perspective view of a Rim Dish apparatus filled (or with a sponge that is saturated) with the Coating solution and typical drink-ware type inverted and prepared for introduction/depression into the Coating Solution/sponge applicator.

FIG. 2 is a perspective view of a Container or reservoir filled with Spice and typical drink-ware inverted, whose rim is moistened and prepared for introduction/depression into the Spice.

### DETAILED DESCRIPTION

Before explaining the present inventions in detail it is to be understood that the inventions are not limited in their application to the particular arrangements shown and described since the inventions are capable of utilizing other devices. Also, the terminology used herein is for the purpose of description and not of limitation.

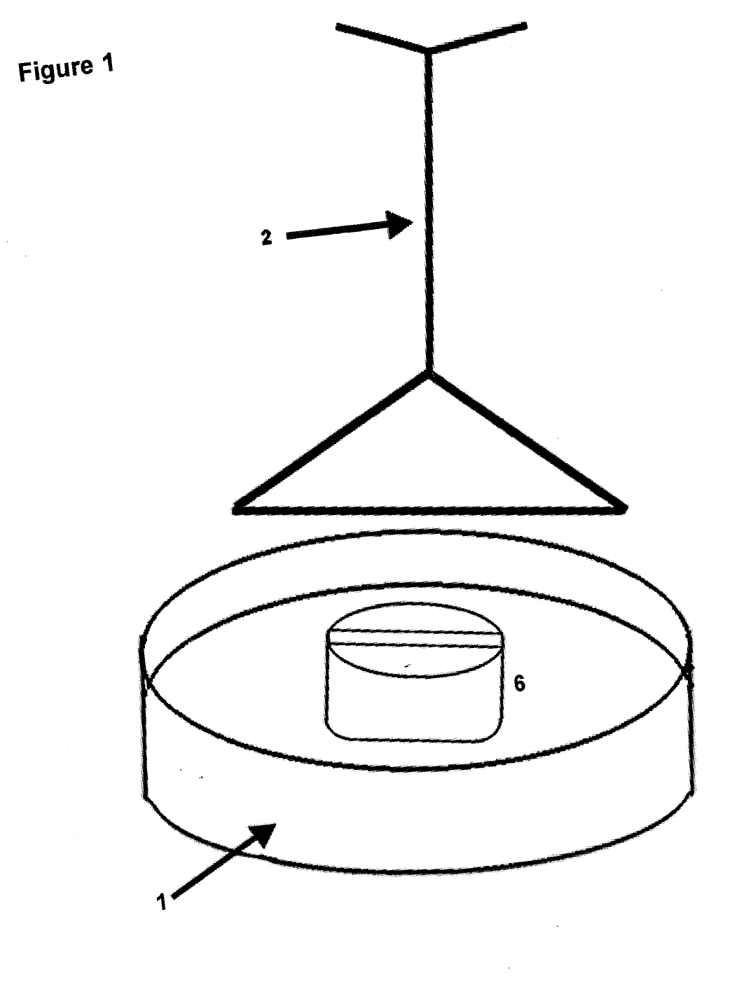

Referring to FIG. 1, is one example for the application of the inventions, a receptacle (1) for the Coating Solution, which may house the Coating Solution directly (6) or may house an applicator such as a sponge (not shown) that is saturated with the Coating Solution. The drink-ware (2) is held inverted and is inserted to the desired depth, generally one quarter to one half inch (¼ to ½ inch) into the Coating Solution.

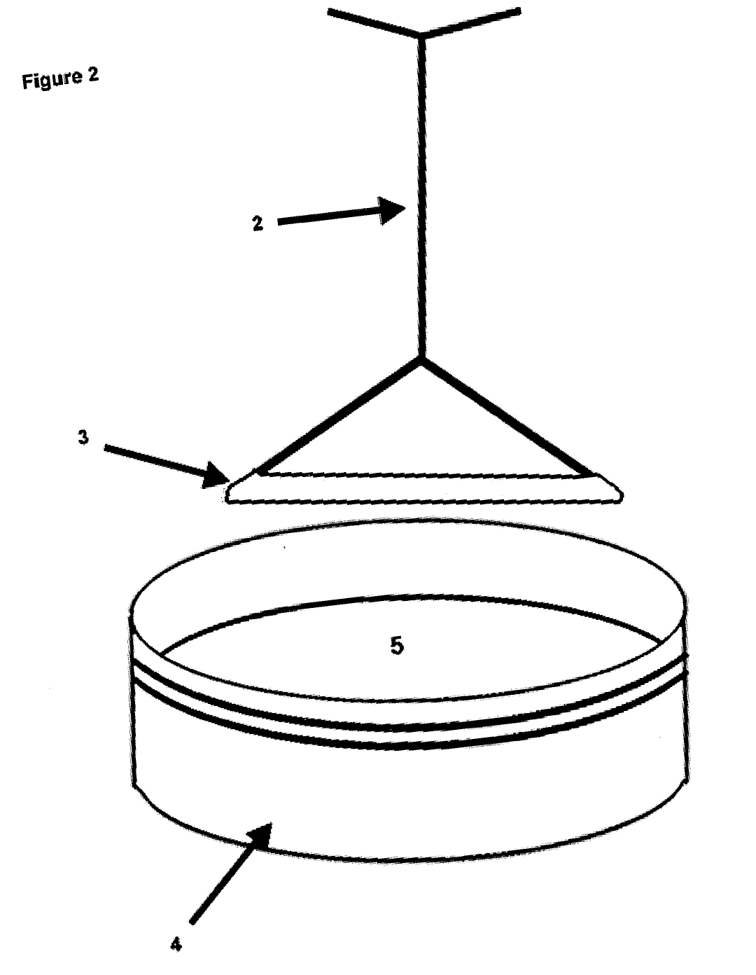

The rim of the drink-ware (pictured here inverted) is coated with a fine and evenly distributed application of Coating Solution (3) as shown in FIG. 2. FIG. 2 further shows the container of Spice (4). The drink-ware rim (3) is then introduced into the Spice (5) so that the Spice adheres to the drink-ware in those locations that are depressed into the Spice and are also coated with the Coating Solution, e.g. the rim of the drink-ware.

These inventions provide novel and improved Coating Solutions for preparing a beverage with drink-ware whose rim is to be coated with a Spice. Examples of several Spice compositions were tested and include sugars and salts of various textures (coarse granules to fine powder) and compositions including sucrose, fructose, artificial sweeteners, sodium, chloride, potassium and others, and cocoa, vanilla, and other dry granular, shaved or flaked spices in various flavors and types. Each were used independently and/or associated with various consumable colorants and natural and artificial flavors. These are presently believed to be the usable compounds for applying presently known rimming materials, for example Spice (dry granular, flaked, shaved or powder substance—herein referred to as Spice), to common drink-ware.

In accordance with one such method, the Coating Solution is applied to and saturates the sponge. The drink-ware is inverted and introduced into the sponge to coat the rim of the drink-ware. The inverted drink-ware is introduced into a layer of Spice, for example in a container or reservoir that houses the Spice which adheres to the rim of the drink-ware.

One example of the present inventions contains both viscous enhancing ingredients and surfactants so that the Coating Solution forms a lipophilic and hydrophilic compound which may create a coated surface on the rim of common glass, ceramic, porcelain, plastic (including the many different plastic types), paper and coated (such as with a wax) type drink-ware. In the present context, texture refers to the material or fluid characteristic known to those in the food industry that provides thickness or feel to a food, or provides greater viscosity, such as that provided by corn syrup, xanthan gum, propylene glycol alginate or other gums. In the present context, a surfactant refers to those compounds that are consumable and that reduce the surface tension of an aqueous solution. Examples include ethyl alcohol and polysorbate.

In one aspect of the present inventions, the viscosity, measured in centipoise, and surfactant compounds increase the Kinematic Viscosity of the Coating Solution to adhere with greater force to the surface of the drink-ware material, form an even distribution of moisture about the surface of the drink-ware rim, and reduce the surface tension to resist the magnetic polarization of the water content in the solution.

In one preferred form, the Coating Solution does not significantly change the perceived taste, aroma, or texture of the Spice. The invention therefore has particular utility in allowing the use of a wide variety of rimming Spices, including granular Spices, flaked or shaved Spices and powders, which have been formulated for specific consistency, texture, flavor, color and aroma. To the extent that the Coating Solution does not alter, change, impede or affect these profiles, the more efficacious the Coating Solution is for the desired beverage design.

In one example of the Coating Solutions, the Coating Solution has an improved shelf life by the incorporation of preservatives. In the examples given herein, the preservatives are of a sufficient quantity and type that neither impact flavor nor color, while simultaneously allowing users to use the same Coating Solution over a reasonable time and between cleaning the same dispensing apparatus such as a sponge. The fact that current or conventional solutions are simply juices or water based concoctions subject each to bacterial contamination.

It will be apparent that a number of beneficial features can be included in compositions and methods for rimming drink ware. Features include, but are not limited to:

1) A viscous solution, gel or liquid (Coating Solution) which serves as a catalyst or facilitator to apply dry granular, flaked, shaved or powder food substances (Spice) to the rim of plastic and glass drink-ware.

Where the Coating Solution may be applied directly to the rim of the drink-ware (e.g. administering the Solution directly to the surface of the drink-ware) or indirectly (e.g. by means of an applicator such as a sponge where the sponge is saturated with the Solution and the drink-ware is then introduced into the applicator) to the rim of drink-ware to apply the Spice to the drink-ware.

2) A Coating Solution such as that described above in paragraph numbered 1, that has lowered surface tension.
3) A Coating Solution such as that described above in paragraph numbered 1, that contains Kinematic Viscosity enhancing ingredients to increase the Sheer Stress to adhere the Solution and corresponding Spice with greater force on the rim of common plastic and glass drink-ware.
4) A Coating Solution such as that described above in paragraph numbered 1, that imparts little to no flavor or color to the Spice and or beverage.
5) A Coating Solution such as that described above in paragraph numbered 1, that contains neutral flavored preservatives to avoid bacterial contamination when un-refrigerated and/or exposed to open air.

TABLE 1
Range 1 - Aqueous No Alcohol

| | | Percentage Range |
|---|---|---|
| Ingredient | Purpose | (Weight) |
| Corn Syrup Type 42/43 | Texture Modifier/Flavor | 15%-50% |
| Water | Base | 40%-60% |
| Propylene Glycol | Dispersing Agent | 0%-4% |
| Polysorbate 60 | Surfactant | 0%-2% |
| Polysorbate 80 | Surfactant | 0%-1.5% |
| Xathan Gum | Viscosity/Texture | 0%-3% |
| | Modifier | |
| Gum Arabic | Viscosity/Texture | 0%-2% |
| | Modifier | |
| Malic Acid | Preservative | 0%-0.5% |
| Sodium Benzoate | Preservative | 0%-0.1% |
| Propylene Glycol | Viscosity/Texture | 0%-0.3% |
| Alginate | Modifier | |
| Carboxymethylcellouse | Viscosity/Texture | 0%-.2% |
| (CMC) | Modifier | |
| Potassium Sorbate | Preservative | 0.10% |

TABLE 2
Range 2 Aqueous With Alcohol

| | Percentage |
|---|---|
| Ingredient | (based on weight) |
| Sugar | 0%-50% |
| Distilled/Purified Water | 20%-51% |
| De-Natured Alcohol | 11%-21% |
| Corn Syrup (42DE/43Baume) | 9%-15% |
| Gum Arabic (premium spray dried) | 0%-1% |
| Xathan Gum 200 mesh transparent/quick | 0%-1% |
| dispersing | |
| Polysorbate 60 or 80 | 0%-1% |

TABLE 3
RANGE 3 LIPID

| | Percentage |
|---|---|
| Ingredient | (based on weight) |
| Sunflower/safflower oil | 0%-100% |
| Canola Oil | 0%-100% |
| Soybean Oil | 0%-100% |
| Coconut Oil | 0%-100% |
| Water | 0-50% |
| Lecethin | 0-3% |
| Citric Acid | 0-.5% |
| Antifoam | 0%-1% |

### Example 1

| | | Percentage |
|---|---|---|
| Ingredient | Purpose | (Weight) |
| Corn Syrup Type 42 | Texture Modifier/Flavor | 49.30% |
| Water | Base | 46.60% |
| Propylene Glycol | Dispersing Agent | 2.30% |
| Polysorbate 60 | Surfactant | 0.90% |
| Xathan Gum | Viscosity/Texture | 0.30% |
| | Modifier | |
| Malic Acid | Preservative | 0.30% |
| Sodium Benzoate | Preservative | 0.10% |
| Propylene Glycol | Texture Modifier | 0.10% |
| Alginate | | |
| Potassium Sorbate | Preservative | 0.10% |
| Total | | 100.00% |

### Example 2

| Ingredient | Percentage |
|---|---|
| Sugar | 48% |
| Distilled Water | 20% |
| Alcohol | 21% |
| Corn Syrup | 10% |
| Gum Arabic (premium spray dried) | 1% |
| Total | 100% |

### Example 3

| | Percentage |
|---|---|
| | (based on |
| Ingredient | weight) |
| Sugar | 38% |
| Distilled Water | 25% |
| Alcohol | 21% |
| Corn Syrup | 15% |
| Gum Arabic (premium spray dried) | 1% |
| Total | 100% |

### Example 4

| | Percentage |
|---|---|
| | (based on |
| Ingredient | weight) |
| Sugar | 48% |
| Distilled/Purified Water | 21% |
| De-Natured Alcohol | 19% |
| Corn Syrup (42DE/43Baume) | 11% |
| Gum Arabic (premium spray dried) | 1% |
| Total | 100% |

### Example 5

| | Percentage |
|---|---|
| | (based on |
| Ingredient | weight) |
| Sugar | 30.0% |
| Distilled/Purified Water | 33.5% |
| De-Natured Alcohol | 20.0% |
| Corn Syrup (42DE/43Baume) | 15.0% |
| Gum Arabic (premium spray dried) | 1.0% |
| Xathan Gum 200 mesh transparent | 0.5% |
| Total | 100.0% |

### Example 6

| | Percentage |
|---|---|
| | (based on |
| Ingredient | weight) |
| Sugar | 26.03% |
| Distilled/Purified Water | 51.24% |
| De-Natured Alcohol | 11.89% |
| Corn Syrup (42DE/43Baume) | 9.54% |
| Gum Arabic (premium spray dried) | 0.87% |
| Xathan Gum 200 mesh transparent | 0.43% |
| Total | 100.00% |

### Example 7

| | Percentage |
|---|---|
| | (based on |
| Ingredient | weight) |
| Sugar Corn Syrup (42DE/43Baume) | 26.03% |
| Distilled/Purified Water | 51.24% |
| De-Natured Alcohol | 11.89% |
| Corn Syrup (42DE/43Baume) | 9.54% |
| Gum Arabic (premium spray dried) | 0.87% |
| Xathan Gum 200 mesh transparent | 0.43% |
| Total | 100.00% |

### Example 8

| | Percentage |
|---|---|
| | (based on |
| Ingredient | weight) |
| Sugar | 20% |
| Distilled/Purified Water | 49.50% |
| De-Natured Alcohol | 20.15% |
| Corn Syrup (42DE/43Baume) | 9% |
| Gum Arabic (premium spray dried) | 0.85% |
| Xathan Gum 200 mesh transparent/ | 0.25% |
| quick dispersing (pretreated w/ | |
| propylene glycol and/or glycerin) | |
| Polysorbate 60 or 80 | 0.25% |
| Total | 100.00% |

### Example 9

| | Percentage |
|---|---|
| | (based on |
| Ingredient | weight) |
| Sugar | 30.00% |
| Corn Syrup (42DE/43Baume) | 15.00% |
| Distilled/Purified Water | 52.50% |
| Gum Arabic (premium spray dried) | 1.30% |
| Xathan Gum 200 mesh transparent/ | 0.30% |
| quick dispersing (or pretreated w/ | |
| propylene glycol and/or glycerin) | |
| Polysorbate 80 | 0.90% |
| Preservative | n/a |
| Total | 100.00% |

### Example 10

| Ingredient | Purpose | Percentage |
|---|---|---|
| Corn Syrup Type 42 | Texture Modifier/Flavor | 48.10% |
| Water | Base | 46.60% |
| Propylene Glycol | Dispersing Agent | 2.30% |
| Polysorbate 60 | Surfactant | 0.90% |
| Xathan Gum | Viscosity/Texture Modifier | 1.50% |
| Malic Acid | Preservative | 0.30% |
| Sodium Benzoate | Preservative | 0.10% |
| Propylene Glycol Alginate | Texture Modifier | 0.10% |
| Potassium Sorbate | Preservative | 0.10% |
| Total | | 100.00% |

### Example 11

| Ingredient | Purpose | Percentage |
|---|---|---|
| Corn Syrup Type 42 | Texture Modifier/Flavor | 49.50% |
| Water | Base | 46.60% |
| Propylene Glycol | Dispersing Agent | 2.30% |
| Polysorbate 60 | Surfactant | 0.90% |
| Malic Acid | Preservative | 0.30% |
| Sodium Benzoate | Preservative | 0.10% |
| Propylene Glycol Alginate | Texture Modifier | 0.20% |
| Potassium Sorbate | Preservative | 0.10% |
| Total | | 100.00% |

### Example 12

| Ingredient | Purpose | Percentage |
|---|---|---|
| Corn Syrup Type 42 | Texture Modifier/Flavor | 49.50% |
| Water | Base | 46.60% |
| Propylene Glycol | Dispersing Agent | 2.30% |
| Polysorbate 60 | Surfactant | 0.90% |
| Malic Acid | Preservative | 0.30% |
| Sodium Benzoate | Preservative | 0.10% |
| Carboxymethylcellouse | Texture Modifier | 0.20% |
| (CMC) | | |
| Potassium Sorbate | Preservative | 0.10% |
| Total | | 100.00% |

### Example 13

| Ingredient | Purpose | Percentage |
|---|---|---|
| Corn Syrup Type 42 | Texture Modifier/Flavor | 47.50% |
| Water | Base | 46.60% |
| Propylene Glycol | Dispersing Agent | 2.30% |
| Polysorbate 60 | Surfactant | 1.50% |
| Xathan Gum | Viscosity/Texture | 1.50% |
| | Modifier | |
| Malic Acid | Preservative | 0.30% |
| Sodium Benzoate | Preservative | 0.10% |
| Propylene Glycol Alginate | Texture Modifier | 0.10% |
| Potassium Sorbate | Preservative | 0.10% |
| Total | | 100.00% |

### Example 14

| Ingredient | Percentage |
|---|---|
| Soy Oil | 10% |
| Water | 68.975% |
| Sugar | 20% |
| Polysorbate 80 | 0.025% |
| Antifoam | 1.000% |
| Total | 100.000% |

### Examples 15-19

| Ingredient | %-age 1 | %-age 2 | %-age 3 | %-age 4 | %-age 5 |
|---|---|---|---|---|---|
| Sunflower/safflower | 100% | | | 30% | 15.00% |
| oil | | | | | |
| Canola Oil | | 100% | | 30% | 15.00% |
| Soybean Oil | | | 100% | 30% | 15.00% |
| Coconut Oil | | | | 10% | 5.00% |
| Water | | | | | 46.50% |
| Lecethin | | | | | 3.00% |
| Citric Acid | | | | | 0.50% |
| Total | 100% | 100% | 100% | 100% | 100.00% |

1-33. (canceled)

34. A method of applying a substance to at least part of a rim of a support for a consumable, the method comprising the steps of:
applying a film containing a surfactant to the at least part of the rim wherein the film is a fluid having a viscosity greater than 1.5 cp at approximately 25 degrees Celsius; and
applying the substance to the film.

35. The method of claim 34 wherein the step of applying the film includes the step of applying a film to at least part of a rim of a beverage container.

36. The method of claim 35 wherein the step of applying the substance includes the step of applying a spice to the film.

37. The method of claim 34 wherein the step of applying a film includes the step of applying the fluid to an applicator and applying the film to the at least part of the rim with the applicator.

38. The method of claim 34 wherein the step of applying a film includes the step of applying an aqueous film.

39. A method of applying a substance to at least part of a rim of a support for a consumable, the method comprising the steps of:
applying a film containing a sorbate to the at least part of the rim wherein the film is a fluid having a viscosity greater than approximately 1.5 cp at approximately 25 degrees Celsius; and
applying the substance to the film.

40. The method of claim 39 wherein the step of applying the film includes the step of applying a film to at least part of a rim of a beverage container.

41. The method of claim 40 wherein the step of applying the substance includes the step of applying a spice to the film.

42. The method of claim 39 wherein the step of applying a film includes the step of applying the fluid to an applicator and applying the film to the at least part of the rim with the applicator.

43. The method of claim 39 wherein the step of applying a film includes the step of applying an aqueous film.

44. The method of claim 39 further including applying a film to the at least part of the rim with a sponge.

45. The method of claim 44 further including applying a film to the at least part of the rim with a sponge in a receptacle.

46. The method of claim 39 further including applying a spice to the at least part of the rim.

47. The method of claim 46 further including applying a granular spice to the at least part of rim.

48. The method of claim 46 further including applying a powder spice to the at least part of the rim.

49. The method of claim 46 further including applying the spice with the spice in a receptacle.

50. The method of claim 39 wherein applying a film includes applying a film including an adhesive.

51. The method of claim 50 wherein applying a film including an adhesive includes applying an aqueous film including an adhesive in a concentration of between 0-75 percent by weight.

52. The method of claim 51 wherein applying an aqueous film includes applying an aqueous film including an adhesive in a concentration of between 9-50 percent by weight.

53. The method of claim 52 wherein applying an aqueous film includes applying an aqueous film including an adhesive in a concentration of about 50 percent by weight.

54. The method of claim 39 wherein applying a film includes applying a film including a wetting agent.

55. The method of claim 54 wherein applying a film including a wetting agent includes applying an aqueous film including a wetting agent between 0-21 percent by weight.

56. The method of claim 39 wherein applying a film includes applying a film were the film is a fluid having a viscosity greater than approximately 100 cp.

57. The method of claim 39 wherein applying a film includes applying a film wherein the film is a fluid having a viscosity between approximately 100 cp and 3000 cp.

58. The method of claim 39 wherein applying the film includes applying an adhesive between 9% and 50% by weight, water between 40% and 60% by weight, a wetting agent between 0% and 21% by weight, and a viscosity/texture modifier between 0% and 3% by weight.

59. The method of claim 58 wherein the adhesive is corn syrup between 15% and 50% by weight.

60. The method of claim 58 wherein the wetting agent is alcohol between 11% and 21% by weight.

61. The method of claim 58 wherein the adhesive is corn syrup between 9% and 15% by weight and sugar between 0% and 50% by weight dissolved in water between 20% and 51% by weight.

62. The method of claim 58 wherein the film has a viscosity between approximately 100 cp and approximately 3000 cp at 25 degrees Celsius.
